(19) United States
(12) Patent Application Publication
(10) Pub. No.: US 2021/0373354 A1
(43) Pub. Date: Dec. 2, 2021

(54) LENS DRIVING DEVICE, CAMERA DEVICE, AND ELECTRONIC APPARATUS

(71) Applicant: New Shicoh Motor Co., Ltd., Zhejiang (CN)

(72) Inventor: Kazuyoshi Hagiwara, Kanagawa (JP)

(21) Appl. No.: 17/318,084

(22) Filed: May 12, 2021

(30) Foreign Application Priority Data
May 28, 2020 (CN) 202010469683.0

(51) Int. Cl. G02B 27/64; G03B 5/00

(52) U.S. Cl. CPC G02B 27/646; G03B 2205/0007; G03B 5/00

(57) ABSTRACT

A lens driving device includes a movable body for supporting a lens, a fixed body disposed inside the movable body, a guide mechanism configured to guide the movable body with respect to the fixed body to be movable in an optical axis direction of the lens, and a driving mechanism configured to move the movable body in the optical axis direction with respect to the fixed body. The driving mechanism includes a magnet disposed on one out of the movable body or the fixed body, and a coil and a magnetic member disposed on the other out of the movable body or the fixed body so as to oppose the magnet, with the magnetic member disposed parallel to the coil. The movable body is pressed against the guide mechanism and toward the fixed body by the magnet and the magnetic member. An opening is formed in the magnetic member.

### TECHNICAL FIELD

The present invention relates to a lens driving device, a camera device, and electronic apparatus.

### BACKGROUND ART

Electronic'apparatus such as mobile telephones, smartphones and the like include small camera devices. Such small cameras may include image stabilization functionality such as that described in US Patent Application Publication No. 2015/0049209 A1.

### SUMMARY

A camera module described in US Patent Application Publication No. 2015/0049209 A1 includes a lens support body for supporting a lens, and a frame provided at the periphery of the lens support body. Plural balls are employed to support the lens support body with respect to the frame such that the lens support body is capable of moving in a direction orthogonal to an optical axis direction of the lens. The camera module is further provided with a magnet and a magnetic member opposing the magnet. An attraction force between the magnet and the magnetic member holds the balls interposed between the lens support body and the frame.

However, if a force equal to or greater than the attraction force between the magnet and the magnetic member is imparted, for example when dropped, the lens support body may separate from the balls and the lens support body may then hit with the balls again, thereby imparting shock to the lens support body or frame that makes point contact with the balls. This may cause dents or cracking where the balls make contact, with the result that smooth movement of the lens support body might no longer be possible.

An object of the present invention is to provide a lens driving device, a camera device, and electronic apparatus capable of resolving such issues to secure smooth movement of a lens support body.

One aspect of the present invention is a lens driving device. The lens driving device includes a movable body configured to support a lens, a fixed body disposed inside the movable body, a guide mechanism configured to guide the movable body with respect to the fixed body such that the movable body is movable in an optical axis direction of the lens, and a driving mechanism configured to move the movable body in the optical axis direction with respect to the fixed body. The driving mechanism includes a magnet disposed on one out of the movable body or the fixed body, and a coil and a magnetic member that are disposed on the other out of the movable body or the fixed body so as to oppose the magnet, with the magnetic member disposed parallel to the coil. The movable body is pressed against the guide mechanism and toward the fixed body by the magnet and the magnetic member. An opening is formed in the magnetic member.

Preferably, the opening is divided into two parts in the optical axis direction, or is divided into two pans in a direction orthogonal to the optical axis direction.

Preferably, the guide mechanism includes a guide shaft provided to the fixed body, and a guide hole provided to the movable body to house the guide shaft, and the guide shaft and the guide hole are placed in line contact with each other at two locations by the pressing.

Preferably, in cross-section viewed along the optical axis direction, the guide shaft has a circular profile and the guide hole has a V-shaped profile opening toward the fixed body.

Another aspect of the present invention is a camera device. The camera device includes the lens driving device, and a lens supported by the movable body.

Another aspect of the present invention is electronic apparatus. The electronic apparatus includes the camera device.

### Advantageous Effects of Invention

In the present invention, the driving mechanism that moves the movable body in the optical axis direction is configured by the mutually opposing coil, magnet, and magnetic member. By forming the opening in the magnetic member, attraction force acting between the magnet and the magnetic member can be adjusted to a desired value, and movement of the movable body in the optical axis direction can be smoothly performed.

### BRIEF DESCRIPTION OF THE DRAWINGS

FIG. 1 is an exploded perspective view illustrating a camera device 10 of an exemplary embodiment of the present invention as viewed obliquely from above;

FIG. 2 is an exploded perspective view illustrating a movable body 18 configuring the camera device 10 in FIG. 1 as viewed obliquely from above;

FIG. 3 is an exploded perspective view illustrating the movable body 18 in FIG. 2 as viewed obliquely from below;

FIG. 4 is an exploded perspective view illustrating part of a fixed body 16 employed in the camera device 10 of an exemplary embodiment of the present invention, as viewed obliquely from above;

FIG. 5 is a perspective view illustrating a flexible printed substrate 78 to be attached to the fixed body 16 in FIG. 4;

FIG. 6 is a plan view illustrating the movable body 18 in FIG. 2 as viewed from above;

FIG. 7A is a cross-section as sectioned along line VIIA-VIIA in FIG. 6;

FIG. 7B is a cross-section as sectioned along line VIIB-VIIB in FIG. 6;

FIG. 8A is an enlarged cross-section of the portion VIIIA in FIG. 7A;

FIG. 8B is an enlarged cross-section of the portion VIIIB in FIG. 7A;

FIG. 9A is an enlarged cross-section of the portion IXA in FIG. 7B;

FIG. 9B is an enlarged cross-section of the portion IXB in FIG. 7B; and

FIG. 10 is an enlarged plan view illustrating an optical axis direction guide mechanism 102 of the present exemplary embodiment as viewed from above.

### DESCRIPTION OF THE EMBODIMENTS

Explanation follows regarding an exemplary embodiment of the present invention, with reference to the drawings. Note that although the following exemplary embodiment describes an example of a lens driving device, a camera device, and electronic apparatus of the present invention, there is no intention that the present invention should be limited to the following exemplary embodiment.

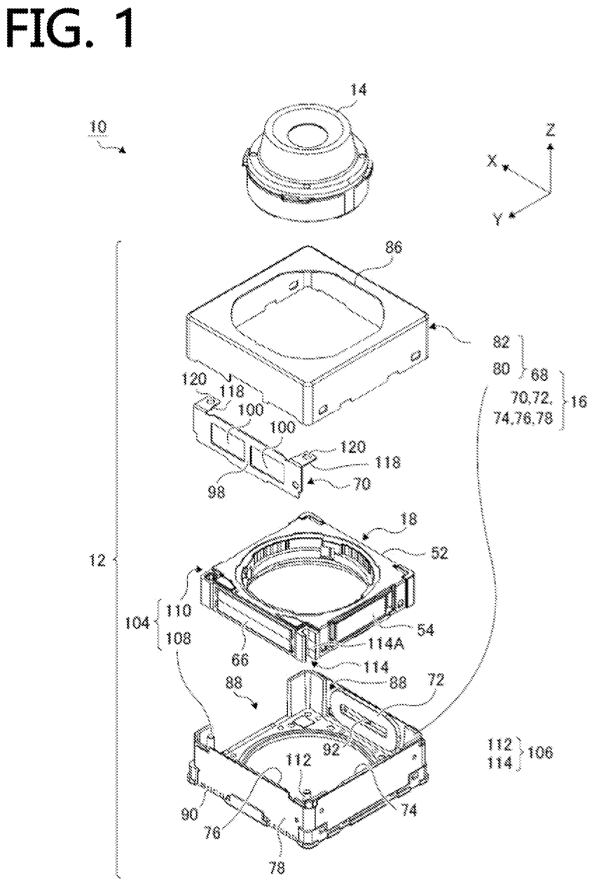

FIG. 1 illustrates a camera device 10 according to the present exemplary embodiment of the present invention. The camera device 10 is installed in electronic apparatus such as a mobile telephone or a smartphone, and includes a lens driving device 12 and a lens 14 mounted to the lens driving device 12.

Note that in the following explanation, for ease of explanation an optical axis direction of the lens 14 is referred to as the Z direction, one direction orthogonal to the Z direction is referred to as the X direction, and a direction orthogonal to both the Z direction and the X direction is referred to as the Y direction. An imaging subject side in the optical axis (corresponding to the upper side in FIG. 1) is referred to as the upper side, and the opposite side thereto, this being the side on which a non-illustrated image sensor is disposed, is referred to as the lower side.

The lens driving device 12 includes a fixed body 16 and a movable body 18 supported by the fixed body 16 so as to be capable of moving in the optical axis direction. The movable body 18 is disposed within the fixed body 16.

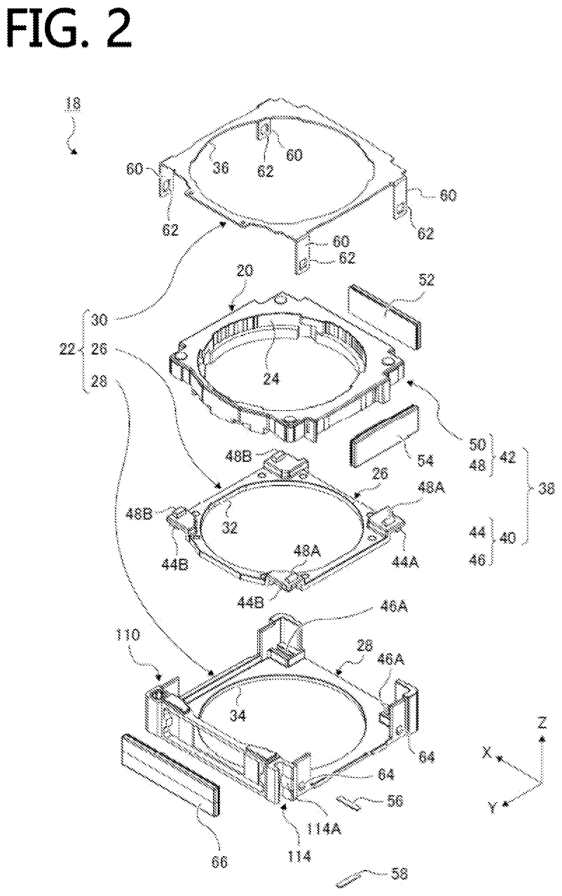

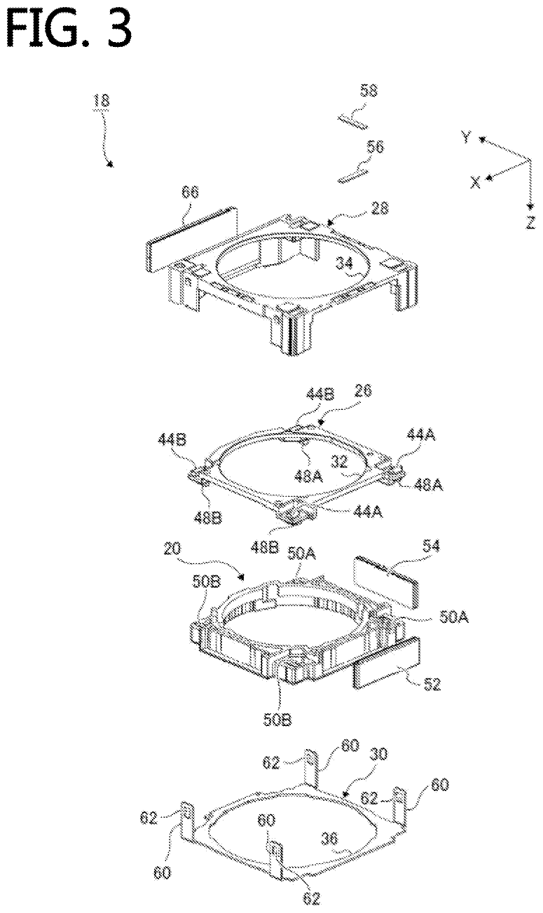

As illustrated in FIG. 2 and FIG. 3, the movable body 18 includes a lens support body 20 to support the lens 14, and a first frame 22 configuring a frame that surrounds the periphery of the lens support body 20. The lens support body 20 and the first frame 22 each have a substantially square external profile as viewed from above.

A lens attachment hole 24 is formed penetrating the inside of the lens support body 20 from the upper side to the lower side. The lens attachment hole 24 is circular as viewed along the Z direction. The lens 14 is attached to the lens attachment hole 24.

The first frame 22 includes a first movable body plate 26, a second movable body plate 28, and a first cover 30, each of which has a substantially square external profile as viewed from above. The first movable body plate 26 and the second movable body plate 28 are, for example, formed from an engineering plastic such as a liquid crystal polymer (LCP), polyacetal, polyimide, polycarbonate, modified-polyphenyleneether, or polybutylene terephthalate. The first cover 30 is, for example, formed from a metal. Openings 32, 34, 36 to allow the passage of light are respectively formed so as to penetrate the first movable body plate 26, the second movable body plate 28, and the first cover 30 from the upper side to the lower side. Each of the openings 32, 34, 36 is substantially circular.

The first frame 22 supports the lens support body 20 so as to allow the lens support body 20 to move in both the X direction, corresponding to a first direction, and the Y direction, corresponding to a second direction. Specifically, the lens, support body 20 and the first frame 22 are provided with an orthogonal direction guide mechanism 38 configuring a guide mechanism, and support the tens support body 20 with respect to the second movable body plate 28, this being a predetermined member configuring a frame, such that the lens support body 20 is capable of moving in both the X direction and the Y direction. The orthogonal direction guide mechanism 38 is configured by a first guide mechanism 40 provided on one side (a lower side) in the Z direction, and a second guide mechanism 42 provided on the other side (an upper side) in the Z direction.

The first guide mechanism 40 is configured by lower side guide projections 44 formed projecting in a −Z direction from a lower face of the first movable body plate 26, and lower side guide grooves 46 formed recessed in the −Z direction in an upper face of the second movable body plate 28 so as to allow the lower side guide projections 44 to fit therein. The lower side guide projections 44 and the lower side guide grooves 46 are formed extending along the X direction in the vicinities of the four corners of the first movable body plate 26 and the second movable body plate 28.

Since the lower side guide projections 44 and the lower side guide grooves 46 extend along the X direction, relative movement is possible in the X direction only, whereas movement in the Y direction is restricted. Accordingly, the first movable body plate 26 is capable of moving in the X direction only, and is restricted from moving in the Y direction, with respect to the second movable body plate 28. Namely, the first guide mechanism 40 enables the lens support body 20 to move together with the first movable body plate 26 in the X direction with respect to the second movable body plate 28.

The lower side guide projections 44 and the lower side guide grooves 46 are disposed on one side and the other side in the Y direction, this being a direction orthogonal to the movement direction of the first movable body plate 26. Specifically, the lower side guide projections 44 include two lower side guide projections 44A, 44A provided on the one side in the Y direction (−Y side), and two lower side guide projections 44B, 44B provided on the other side in the Y direction (Y side). The lower side guide grooves 46 include two lower side guide grooves 46A, 46A provided on the one side in the Y direction, and two lower side guide grooves 468, 46B provided on the other side in the Y direction.

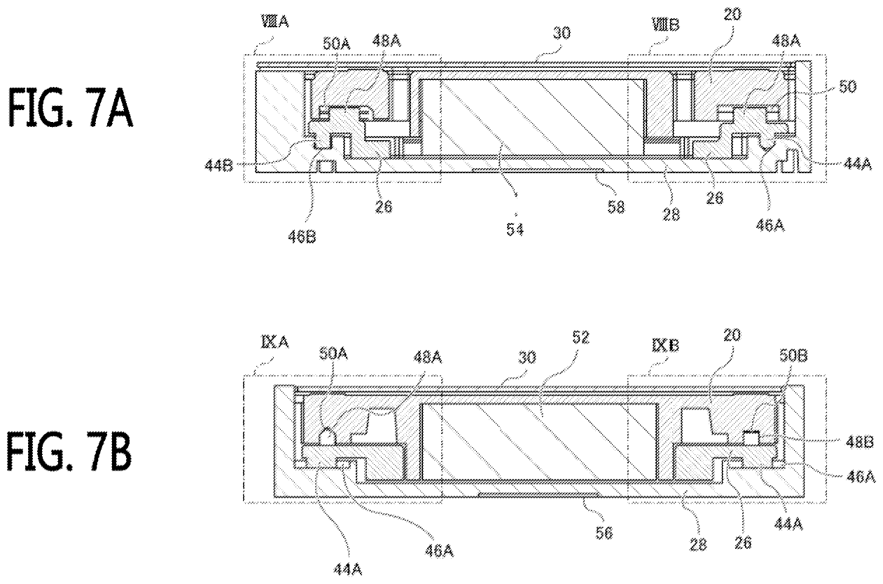

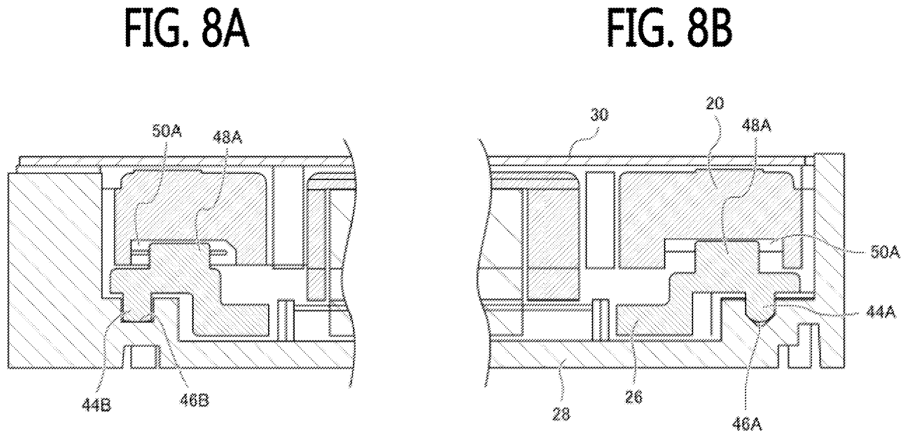

As illustrated in FIG. 7A and FIG. 8B, as viewed along the X direction, the lower side guide grooves 46A, 46A on the one side in the Y direction each have a V-shaped profile with a decreasing width on progression toward the groove bottom thereof, such that the lower side guide grooves 46A, 46A are inclined so as to narrow in width on progression toward the groove bottoms. The lower side guide projections 44A, 44A each have a semicircular profile. Accordingly, arc shaped portions of the lower side guide projections 44A, 44A and linear portions of the lower side guide grooves 46A, 46A make line contact with one another at two locations each. And a space is formed between the lower side guide grooves 46A, 46A and the corresponding lower side guide projections 44A, 44A in a region between the positions of the two locations of line contact and the corresponding groove bottom. The lower side guide projections 44A, 44A may each have a rectangular cross-section profile, in which case the lower side guide grooves 46A, 46A may each have either a U-shaped or a V-shaped cross-section profile. By making line contact at two locations, the Y direction positions of the lower side guide projections 44A, 44A with respect to the lower side guide grooves 46A, 46A are precisely defined.

As illustrated in FIG. 7A and FIG. 8A, as viewed along they X direction, the lower side guide projections 44B, 44B and the lower side guide grooves 46B, 46B on the other side in the Y direction each have a rectangular profile. Namely, groove bottoms of the lower side guide grooves 46B, 46B include planar faces extending in a direction orthogonal to the direction in which the lower side guide projections 44B, 44B and the lower side guide grooves 46B, 46B extend, and the lower side guide projections 44B, 44B includes planar faces that make face-to-face contact with these planar faces. Accordingly, the lower side guide projections 44B, 44B and the lower side guide grooves 46B, 46B that are on the other side in the Y direction make face-to-face contact with each other. This enables the Z direction height of the first movable body plate 26 with respect to the second movable body plate 28 to be defined. The planar faces of the lower side guide grooves 46B, 46B are wider than the lower side guide projections 44B, 44B. Accordingly, even if manufacturing error creates a difference between the distance between the lower side guide projections 44A, 44A and the lower side guide projections 44B, 44B and the distance between the lower side guide grooves 46A, 46A and the lower side guide grooves 46B, 46B, assembly is still possible, and the first movable body plate 26 is able to move smoothly.

The second guide mechanism 42 is configured by upper side guide projections 48 formed projecting in a direction from an upper face, of the first movable body plate 26, and upper side guide grooves 50 formed recessed in the +Z direction in a lower face of the lens support body 20 so as to allow the upper side guide projections 48 to fit therein. The upper side guide projections 48 and the upper side guide grooves 50 are formed extending along the Y direction in the vicinities of the four corners of the first movable body plate 26 and the lens support body 20.

Since the upper side guide projections 48 and the upper side guide grooves 50 extend along the Y direction, relative movement is permitted in the Y direction only, and movement in the X direction is restricted. Accordingly, the lens support body 20 is capable of moving in the Y direction only, and is restricted from moving in the X direction, with respect to the first movable body plate 26. Namely, the second guide mechanism 42 enables the lens support body 20 to move in the Y direction with respect to the first movable body plate 26. The lens support body 20 is accordingly capable of moving in both the X direction and the Y direction with respect to the second movable body plate 28. Moreover, the first guide mechanism 40 and the second guide mechanism 42 configure independent guide mechanisms, and force in a rotation direction about the Z direction is not applied even if drive is perforated simultaneously in the X and Y directions, thereby enabling the lens support body 20 to be prevented from oscillating in the rotation direction.

The upper side guide projections 48 and the upper side guide grooves 50 are disposed on one side and the other side in the X direction, this being a direction orthogonal to the movement direction of the lens support body 20. Specifically, the upper side guide projections 48 include two upper side guide projections 48A, 48A provided on the one side in the X direction (a −X side), and two upper side guide projections 48B, 48B provided on the other side in the X direction (a +X side). The upper side guide grooves 50 include two upper side guide grooves 50A, 50A provided on the one side in the X direction, and two upper side guide grooves 50B, 50B provided on the other side in the X direction.

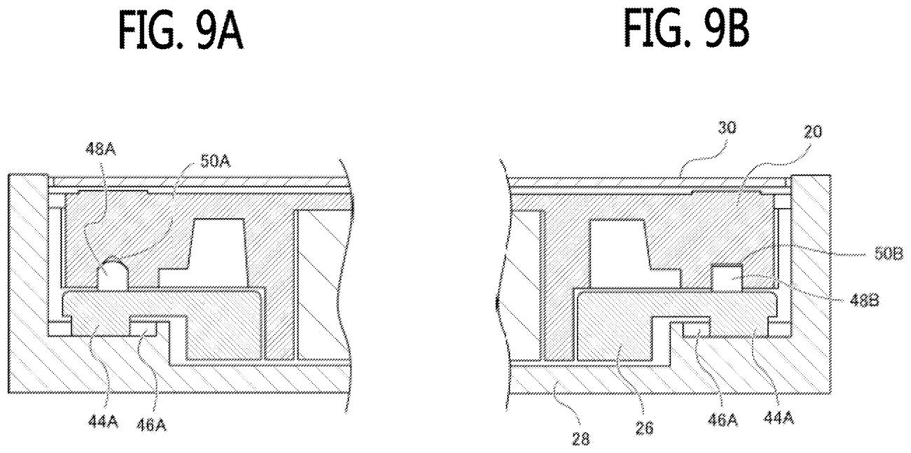

As illustrated in FIG. 7B and FIG. 9A, as viewed along the Y direction, the upper side guide grooves 50A, 50A on the one side in the X direction each have a V-shaped profile with a decreasing width on progression toward the groove bottom thereof, such that the upper side guide grooves 50A, 50A are inclined so as to narrow in width on progression toward the groove bottoms. The upper side guide projections 48A, 48A each have a semicircular profile. Accordingly, arc shaped portions of the upper side guide projections 48A, 48A and linear portions of the upper side guide grooves 50A, 50A make line contact with one another at two locations each. A space is formed between the upper side guide projections 48A, 48A and the corresponding upper side guide grooves 50A, 50A in a region between the positions of the two locations of line contact and the corresponding groove bottom. The upper side guide projections 48A, 48A may each have a rectangular cross-section profile, in which case the upper side guide grooves 50A, 50A may each have either a U-shaped or a V-shaped cross-section profile. By making line contact at two locations each, the X direction positions of the upper side guide projections 48A, 48A with respect to the upper side guide grooves 50A, 50A are precisely defined.

As illustrated in FIG. 7B and FIG. 9B, as viewed along the Y direction, the upper side guide projections 48B, 48B and the upper side guide grooves 50B, 50B on the other side in the X direction each have a rectangular profile. Namely, groove bottoms of the upper side guide grooves 50B, 50B include planar faces extending in a direction orthogonal to the direction in which the upper side guide projections 48B, 48B and the upper side guide grooves 50B, 50B extend, and the upper side guide projections 48B, 48B include planar faces that make face-to-face contact with these planar faces. Accordingly, the upper side guide projections 48B, 48B and the upper side guide grooves 50B, 50B that are on the other side in the X direction make face-to-face contact with each other. This enables the Z direction height of the lens support body 20 with respect to the first movable body plate 26 to be defined. The planar faces of the upper side guide grooves 50B, 50B are wider than the upper side guide projections 48B, 48B. Accordingly, even if manufacturing error creates a difference between the distance between the upper side guide projections 48A, 48A and the upper side guide projections 48B, 48B and the distance between the upper side guide grooves 50A, 50A and the upper side guide grooves 50B, 50B, assembly is still possible, and the lens support body 20 is able to move smoothly.

A plate shaped first magnet 52 and a plate shaped second magnet 54 are fixed to outer sides of the lens support body 20. The first magnet 52 is disposed with its plate faces facing along the Y direction on the one side in the Y direction, this being the side on which the lower side guide projections 44A, 44A and the lower side guide grooves 46A, 46A make line contact with each other. The second magnet 54 is disposed with its plate faces facing along the X direction on the one side in the X direction this being the side on which the upper side guide projections 48A, 48A and the upper side guide grooves 50A, 50A make line contact with each other. The S pole of the first magnet 52 is provided on one of the plate faces facing in the Y direction, and the N pole is provided on the other of these plate faces. The S pole of the second magnet 54 is provided on one of the plate faces facing in the X direction, and the N pole is provided on the other of these plate faces.

A first magnetic member 56 and a second magnetic member 58, each configured by a magnetic body, are disposed at a lower face of the second movable body plate 28. The first magnetic member 56 is disposed on the one side in the Y direction so as to run along the X direction parallel to the first magnet 52. The second magnetic member 58 is disposed on the one side in the X direction so as to run along the Y direction parallel to the second magnet 54. Accordingly, the first magnetic member 56 opposes the first magnet 52 in the Z direction with the second movable body plate 28 interposing therebetween, and similarly the second magnetic member 58 opposes the second magnet 54 in the Z direction with the second movable body plate 28 interposing therebetween.

The first magnet 52 and the first magnetic member 56 on the one side in the Y direction are disposed between a pair configured by one oldie lower side guide projections 44A and one of the lower side guide grooves 46A and a pair configured by the other of the lower side guide projections 44A and the other of the lower side guide grooves 46A, and attract one another. The lower side guide projections 44A, 44A and the lower side guide grooves 46A, 46A that are in line contact with one another accordingly make tighter contact with one another than they would were the first magnet 52 and the first magnetic member 56 to be disposed at another position, and can therefore be more precisely positioned in the Y direction.

The second magnet 54 and the second magnetic member 58 on the one side in the X direction are disposed between a pair of configured by one of the upper side guide projections 48A and one of the upper side guide grooves 50A and a pair configured by the other of the upper side guide protections 48A and the other of the upper side guide grooves 50A, and attract one another. The upper side guide projections 48A, 48A and the upper side guide grooves 50A, 50A that are in line contact with one another accordingly make tighter contact with one another than they would were the second magnet 54 and the second magnetic member 58 to be disposed at another position, and can therefore be more precisely positioned in the X direction.

Attachment portions 60 are provided extending downward in the Z direction at the four corners of the first cover 30. Each of the attachment portions 60 is formed with a square attachment hole 62. Counterpart attachment portions 64 are formed protruding sideways at the four corners of the second movable body plate 28. The counterpart attachment portions 64 fit into the respective attachment holes 62 so as to fix the first cover 30 to the second movable body plate 28. Note that as illustrated in FIG. 7A and FIG. 7B, a minimum required gap to allow for error arising due to tolerance or the like is present between a lower face of the first cover 30 and an upper face of the lens support body 20. The lens support body 20, the first movable body plate 26, and the second movable body plate 28 are thus restricted from separating excessively from one another even when subjected to shock.

A plate shaped third magnet 66 is fixed to an outer face on the side of the second movable body plate 28, this being the opposite side to the side where the first magnet 52 is provided. Plate faces of the third magnet 66 thee in the Y direction. The third magnet 66 is divided into two parts, namely a Z direction upper side part and a Z direction lower side part. The S pole and the N pole are at the plate faces of the third magnet 66, and the polarity is reversed between the upper side and the lower side.

As illustrated in FIG. 1, the fixed body 16 includes a second frame 68 provided with a base 80 and a second cover 82, a third magnetic member 70 attached to the second frame 68, a first coil 72, a second coil 74, a third coil 76, and a flexible printed substrate 78. The base 80 and the second cover 82 are each configured from a resin or a non-magnetic metal, and each have a square profile as viewed along the Z direction from above. The second cover 82 is fitted onto the outside of the base 80 in order to configure the second frame 68. The second frame 68 surrounds the periphery of the first frame 22 of the movable body 18. The base 80 and the second cover 82 are formed with respective through holes 84, 86 to allow light to pass or to allow insertion of the lens 14.

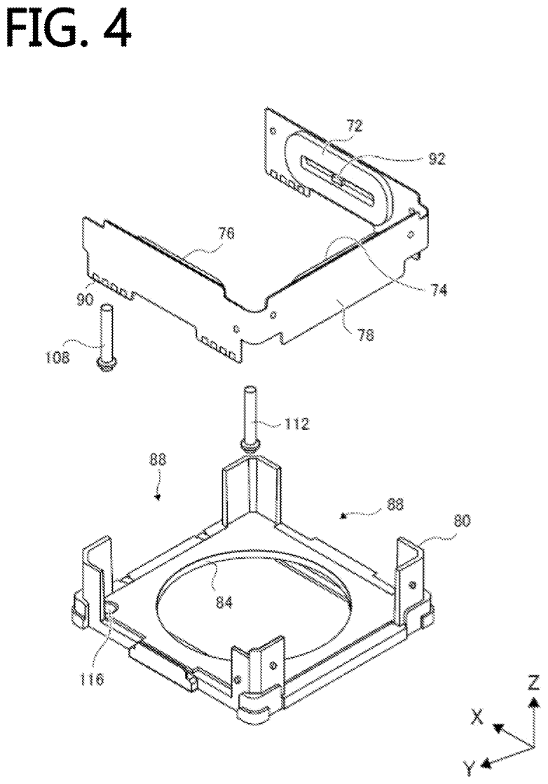

As illustrated in FIG. 1 and FIG. 4, openings 88 that are open toward the Z direction upper side are respectively formed in the four side faces of the base 80. The above-mentioned flexible printed substrate 78 is disposed so as to surround three of the side faces of the base 80. Namely, the flexible printed substrate 78 is folded in an angular C shape so as to enclose the two side faces of the base 80 that run orthogonally to the Y direction and one of the side faces (the side face on the −X side) of the base 80 that runs orthogonally to the X direction.

At the inside of the flexible printed substrate 78, the first coil 72 and the third coil 76 are fixed to two faces that run orthogonally to the Y direction, and the second coil 74 is fixed to one face that runs orthogonally to the X direction. A Z direction lower portion of the flexible printed substrate 78 is provided with a terminal 90, and current supply, signal output, and the like are performed through the terminal 90.

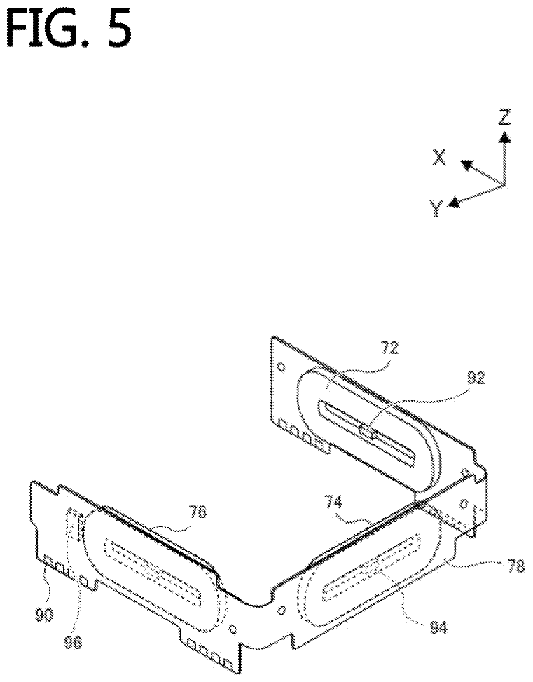

As illustrated in FIG. 5, at the inside of the flexible printed substrate 78, a Y direction position detection element 92 is disposed at a center side of the first coil 72, and an X direction position detection element 94 is disposed at a center side of the second coil 74, and a Z direction position detection element 96 is disposed at a position adjacent to the third coil 76.

The first coil 72 and the Y direction position detection element 92 are disposed inside the corresponding opening 88 so as overlook the inside of the base 80 and oppose the first magnet 52. Similarly, the second coil 74 and the X direction position detection element 94 are disposed inside the corresponding opening 88 so as to oppose the second magnet 54. The third coil 76 and the Z direction position detection element 96 are disposed inside the corresponding opening 88 so as to oppose the third magnet 66.

As illustrated in FIG. 1, the third magnetic member 70 that is configured by a magnetic body is disposed at the outer side of a portion of the flexible printed substrate 78 to which the third coil 76 is fixed so as to be parallel to the third coil 76. The third magnetic member 70 is fixed so as to be placed in close contact with a side face of the base 80 with the flexible printed substrate 78 interposed therebetween. The third magnetic member 70 thereby opposes the third magnet 66 across the flexible printed substrate 78 and the third coil 76.

Magnetic flux from the third magnet 66 flows in the third magnetic member 70, causing an attraction force to arise between the third magnet 66 and the third magnetic member 70. An attraction three in the Y direction with respect to the fixed body 16 accordingly acts on the movable body 18.

The third magnetic member 70 is formed with two divided openings 100, 100 that are divided into two parts in the X direction by a coupling portion 98 extending along the Z direction. The coupling portion 98 may extend along the X direction, in which case the divided openings 100, 100 would be divided into two parts in the Z direction. The third magnetic member 70 is formed from magnetic stainless steel or plated iron. By forming the third magnetic member 70 with the divided openings 100, 100, the attraction force between the third magnet 66 and the third magnetic member 70 can be adjusted to a desired strength. Namely, the attraction force between the third magnet 66 and the third magnetic member 70 can be set so as to be comparatively weak in comparison to a Z direction drive force between the third coil 76 and the third magnet 66. This enables the drive force required for Z direction movement to be made smaller, and also enables the damage to an optical axis direction guide mechanism 102, described later, when subjected to external shock, to be reduced.

As illustrated in FIG. 1, the movable body 18 is supported by the optical axis direction guide mechanism 102 so as to be capable of moving in the Z direction with respect to the fixed body 16. Namely, the optical axis direction guide mechanism 102 guides the first frame 22 so as to allow the first frame 22 to move along the Z axis direction with respect to the second frame 68. Namely, the lens support body 20 is guided so as to be capable of moving along the optical axis direction together with the first frame 22. The optical axis direction guide mechanism 102 is configured by a third guide mechanism 104 and a fourth guide mechanism 106. The third guide mechanism 104 is configured by a +X side guide shaft 108 provided to the second frame 68 and a +X side guide hole 110 provided to the movable body 18 so as to house the +X side guide shaft 108. The fourth guide mechanism 106 is configured by a −X side guide shaft 112 provided to the second frame 68 and a −X side guide groove 114 provided to the movable body 18.

In the present exemplary embodiment, the +X side guide shaft 108 and the −X side guide shaft 112 are each formed as circular columns extending along the Z direction, and are for example formed from ceramic, a metal, or a resin. The +X side guide shaft 108 and the −X side guide shaft 112 are each disposed in the vicinity of an inside corner of the side face of the base 80 where the third coil 76 is disposed. Note that although the +X side guide shaft 108 and the −X side guide shaft 112 each have a circular cross-section profile in an X-Y plane, this circular profile may be provided locally, or may be elliptical in shape. A polygonal profile such as a square profile may also be applied.

Lower side fixing portions 116, 116 are provided to a bottom face at the periphery of the through hole 84 in the base 80 in the vicinity of the corners of the side face where the third coil 76 is disposed. Each of the lower side fixing portions 116, 116 has a circular tube shape and is formed with an insertion groove. Lower ends of the +X side guide shaft 108 and the −X side guide shaft 112 are inserted into and fixed to the respective lower side fixing portions 116, 116. Both X direction ends of an upper end of the third magnetic member 70 described above are formed with upper side fixing portions 118, 118 that are folded in the Y direction. An insertion hole 120 is formed through each of the upper side fixing portions 118. Upper ends of the +X side guide shaft 108 and the −X side guide shaft 112 are inserted into and fixed to the respective insertion holes 120, 120. The +X side guide shaft 108 and the −X side guide shaft 112 are thus fixed to the base 80. The third magnetic member 70 thereby has an additional function of supporting the +X side guide shaft 108 and the −X side guide shaft 112, thereby enabling the number of components to be reduced in comparison to cases in which this support function is performed by separate components, and enabling the +X side guide shaft 108 and the −X side guide shaft 112 to be stably supported.

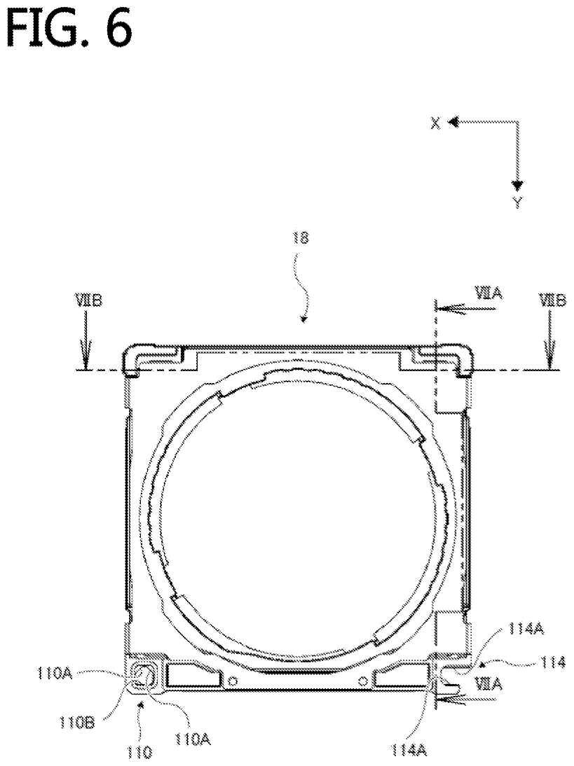

As illustrated in FIG. 2 and FIG. 6, the +X side guide hole 110 is formed as a hollow through hole penetrating the second movable body plate 28 from a Z direction upper face to a Z direction lower face thereof. On the other hand, the −X side guide groove 114 extends so as to penetrate the second movable body plate 28 from the Z direction upper face to the Z direction lower face, and is formed as a groove opening toward the exterior in the −X direction.

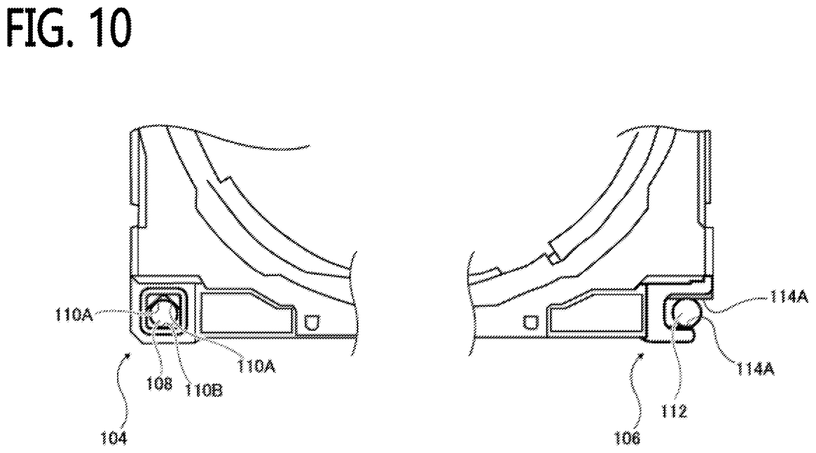

As illustrated in FIG. 6 and FIG. 10, in cross-section viewed along an X-Y plane, the −Y side of the +X side guide hole 110 has a V-shaped profile opening toward the +Y side, this being the fixed body side, and the +Y side of the +X side guide hole 110 has a rectangular profile. Note that the +Y side may have a semicircular cross-section profile.

The pulling force between the third magnet 66 attached to the movable body 18 and the third magnetic member 70 draws the movable body 18 in the +Y direction. Accordingly, at least guide faces 110A, 110A forming the V-shaped profile on the −Y side of the +X side guide hole 110 make line contact with an outer surface of the +X side guide shaft 108 at two locations as viewed along the Z direction. This enables the movable body 18 to be positioned accurately with respect to the fixed body 16 in both the X direction and the Y direction. Note that although it is desirable for a minute gap to be present between the rectangular portion of the +X side guide hole 110 and the outer surface of the +X side guide shaft 108 such that the two do not make line contact with each other, it is acceptable for line contact to occur.

in an X-Y plane cross-section, the −X side guide groove 114 is configured by two wall faces opposing each other in the Y direction. These two wall faces are respectively formed with protrusions 114A, 114A, each with a curved face profile protruding in the Y direction. As illustrated in FIG. 10, the center of at least the protrusion 114A on the −Y side contacts an outer surface of the −X side guide shaft 112. Namely, the −X side guide groove 114 and the −X side guide shaft 112 make point contact with each other at at least one point, such that little frictional resistance arises therebetween. Note that although it is desirable for a minute gap to be present between the protrusion 114A on the +Y side and the outer surface of the −X side guide shaft 112 such that the two do not make point contact, it is acceptable for line contact to occur therebetween. In this manner, the movable body 18 is pressed against the +X side guide shaft 108 and the −X side guide shaft 112 by magnetic force, and so the upper side movable body 18 does not tilt with respect to the +X side guide shaft 108 and the −X side guide shaft 112. Note that an increase in the size of the lens 14 leads to an increase in the weight of the movable body 18 installed with the lens 14. In such cases, it has hitherto been necessary to increase the required pulling force using magnetic force, with the result that frictional force increases and drive force has to be increased by at least an amount commensurate with the increase in the weight of the lens. However, in the present exemplary embodiment, employing the guide shaft structure obviates the need to increase the required pulling force using magnetic force, enabling the drive force to be kept small.

In the lens driving device 12, the first magnet 52 and the first coil 72 configure a driving mechanism to move the lens support body 20 along the Y axis direction with respect to the second movable body plate 28. When the first coil 72 is powered ON, a current flows in the X direction in the first coil 72. The first magnet 52 opposing the first coil 72 generates magnetic flux with a Z direction component such that a Lorentz force in the Y direction acts on the first coil 72. Since the first coil 72 is fixed to the base 80, a reaction acting on the first magnet 52 acts as a drive force on the lens support body 20. The lens support body 20 accordingly moves in the Y direction, guided by the second guide mechanism 42.

After the lens support body 20 has moved in the Y direction, the power to the first coil 72 is stopped. When this is performed, the attraction force between the first magnet 52 and the first magnetic member 56, the attraction force between the second magnet 54 and the second magnetic member 58, friction between the lower side guide projections 44 and the lower side guide grooves 46, and friction between the upper side guide projections 48 and the upper side guide grooves 50 cause the lens support body 20 to stop at the position it is at when power to the first coil 72 is stopped.

Moreover, the second magnet 54 and the second coil 74 configure a driving mechanism to move the lens support body 20 together with the first movable body plate 26 along the X axis direction with respect to the second movable body plate 28. When the second coil 74 is powered ON, a current flows in the Y direction in the second coil 74. The second magnet 54 opposing the second coil 74 generates magnetic flux with a Z direction component such that a Lorentz force in the X direction acts on the second coil 74. Since the second coil 74 is fixed to the base 80, a repulsion effect acting in the second magnet 54 acts as a drive force on the lens support body 20 and the first movable body plate 26. The lens support body 20 and the first movable body plate 26 accordingly move in the X direction, guided by the first guide mechanism 40.

After the lens support body 20 and the first movable body plate 26 have moved in the X direction, the power to the second coil 74 is stopped. When this is performed, the attraction force between the first magnet 52 and the first magnetic member 56, the attraction force between the second magnet 54 and the second magnetic member 58, friction between the lower side guide projections 44 and the lower side guide grooves 46, and friction between the upper side guide projections 48 and the upper side guide grooves 50 cause the lens support body 20 to stop together with the first movable body plate 26 at the position they are at when power to the second coil 74 is stopped.

The third magnet 66, the third coil 76, and the third magnetic member 70 configure a driving mechanism to move the movable body 18 in the optical axis direction with respect to the fixed body 16. When the third coil 76 is powered ON, a current flows in the X direction in the third coil 76. The third magnet 66 opposing the third coil 76 generates magnetic flux in the Y direction such that a Lorentz force in the Z direction acts on the third coil 76. Since the third coil 76 is fixed to the base 80, a repulsion effect acting in the third magnet 66 acts as a drive force on the movable body 18, such that the movable body 18 moves in the Z direction, guided by the optical axis direction guide mechanism 102. Namely, the lens support body 20 moves in the optical axis direction.

After the movable body 18 has moved in the Z direction, the power to the third coil 76 is stopped. When this is performed, the attraction force between the third magnet 66 and the third magnetic member 70, friction between the +X side guide shaft 108 and the +X side guide hole 110, and friction between the −X side guide shaft 112 and the −X side guide groove 114 cause the lens support body 20 included in the movable body 18 to stop at the position it is at when power to the third coil 76 is stopped.

Consider a situation in which the camera device 10 is subjected to shock in the Y direction. Even were the +X side guide shaft 108 and the +X side guide hole 110, and the −X side guide Shaft 112 and the −X side guide groove 114 to move away from one another, such movement away would be over a minute distance and the respective components would promptly return to their original positions, such that any damaged sustained would be negligible. Since the lower side guide projections 44A, 44B and the lower side guide grooves 46A, 46B, as well as the upper side guide projections 48A, 48B and the upper side guide grooves 50A, 50B are respectively retained in contact states, damage is effectively non-existent.

Consider a situation in which the camera device 10 is subjected to shock in the X direction. Since the +X side guide shaft 108 and the +X side guide hole 110, the −X side guide shaft 112 and the −X side guide groove 114, the lower side guide projections 44A, 44B and the lower side guide grooves 46A, 46B, and the upper side guide projections 48A, 48B and the upper side guide grooves 50A, 50B are respectively retained in contact states, damage is effectively non-existent.

Consider a situation in which the camera device 10 is subjected to shock in the Z direction. Since the +X side guide shaft 108 and the +X side guide hole 110, and the −X side guide shaft 112 and the −X side guide groove 114, are retained in contact states, damage is effectively non-existent. Even were the lower side guide projections 44A, 44B and the lower side guide grooves 46A, 46B, and the upper side guide projections 48A, 48B and the upper side guide grooves 50A, 50B, to move away from one another, such movement away would be over a minute distance and the respective components would promptly return to their original positions, and since these respective components are in line contact or face-to-face contact states, damage is effectively non-existent.

Thus, regardless of the direction in which the camera device 10 is subjected to shock, any damage sustained by the lens driving device 12 of the present exemplary embodiment is negligible, or effectively non-existent. This enables smooth movement of the lens support body 20 in each of the X, Y, and Z directions to be secured.

In the exemplary embodiment described above, explanation has been given regarding an example in which the first movable body plate 26 is provided with the lower side guide projections 44 and the upper side guide projections 48, the second movable body plate 28 is provided with the opposing lower side guide grooves 46, and the lens support body 20 is formed with the opposing upper side guide grooves 50. However, the arrangement of projections and grooves may be inverted, such that guide grooves are formed in upper and lower faces of the first movable body plate 26, and opposing guide projections are formed on the second movable body plate 28 and the lens support body 20. Alternatively, the arrangement may be inverted on either one out of the upper side or the lower side.

Moreover, in the exemplary embodiment described above, explanation has been given regarding an example in which the first coil 72, the second coil 74, the third coil 76, and the third magnetic member 70 are attached to the fixed body 16, and the first magnet 52, the second magnet 54, and the third magnet 66 are attached to the movable body 18. However, the first coil 72, the second coil 74, the third coil 76, and the third magnetic member 70 may be attached to the movable body 18, while the first magnet 52, the second magnet 54, and the third magnet 66 may be attached to the fixed body 16.

In the exemplary embodiment described above, explanation has been given regarding the lens driving device 12 employed in the camera device 10. However, the present invention may also be applied in other devices.

1. A lens driving device comprising:
a movable body configured to support a lens;
a fixed body disposed inside the movable body;
a guide mechanism configured to guide the movable body with respect to the fixed body such that the movable body is movable in an optical axis direction of the lens; and
a driving mechanism configured to move the movable body in the optical axis direction with respect to the fixed body;
the driving mechanism including a magnet disposed on one out of the movable body or the fixed body, and a coil and a magnetic member that are disposed on the other out of the movable body or the fixed body so as to oppose the magnet, with the magnetic member disposed parallel to the coil;
the movable body being pressed against the guide mechanism and toward the fixed body by the magnet and the magnetic member; and
an opening being formed in the magnetic member.

2. The lens driving device according to claim 1, wherein the opening is divided into two parts in the optical axis direction, or is divided into two parts in a direction orthogonal to the optical axis direction.

3. The lens driving device according to claim 1, wherein:
the guide mechanism includes a guide shaft provided to the fixed body, and a guide hole provided to the movable body to house the guide shaft; and
the guide shaft and the guide hole are placed in line contact with each other at two locations by the pressing.

4. The lens driving device according to claim 2, wherein:
the guide mechanism includes a guide shaft provided to the fixed body, and a guide hole provided to the movable body to house the guide shaft; and
the guide shaft and the guide hole are placed in line contact with each other at two locations by the pressing.

5. The lens driving device according to claim 3, wherein in cross-section viewed along the optical axis direction, the guide shaft has a circular profile and the guide bole has a V-shaped profile opening toward the fixed body.

6. The lens driving device according to claim 4, wherein in cross-section viewed along the optical axis direction, the guide shaft has a circular profile and the guide hole has a V-shaped profile opening toward the fixed body.

7. A camera device comprising:
the lens driving device of claim 1; and
a lens supported by the movable body.

8. Electronic apparatus comprising the camera device of claim 7.
